(19) United States
(12) Patent Application Publication
(10) Pub. No.: US 2005/0264659 A1
(43) Pub. Date: Dec. 1, 2005

(54) Image acquisition device

(76) Inventor: Aram Novoyan, Embrun (FR)

Correspondence Address: CLARK & BRODY, 1090 VERMONT AVENUE, NW, SUITE 250, WASHINGTON, DC, 20005, US

(21) Appl. No.: 11/138,345

(22) Filed: May 27, 2005

(30) Foreign Application Priority Data
May 28, 2004 (FR) 04 05817

(51) Int. Cl. H04N 7/00

(52) U.S. Cl. 348/240.3

(57) ABSTRACT

The image acquisition device comprises a camera of CMOS type, having a zoom lens, and a motor-driven zoom control unit that is offset. The camera makes it possible to acquire said images at a speed greater than seventy-five images per second. The invention can be used to create slow motion that is broadcast under live TV conditions.

The present invention relates to an image acquisition device, suitable for use in particular in creating slow motion image sequences of excellent quality, and capable of being broadcast under live conditions.

### BACKGROUND OF THE INVENTION

The invention serves in particular to obtain slow motion sequences comprising five hundred images per second, and to broadcast the slow motion sequences immediately after they have been acquired.

It therefore possesses a considerable advantage over all presently existing solutions for producing slow motion live, which solutions are at present restricted to no more than seventy-five images per second.

Consequently, the invention will find particularly advantageous use in the field of playing back sports events live, in particular for real time video verification in support of a referee.

In known manner, the slow motion cameras traditionally used for playing back sports events live make use of charge-coupled devices (CCDs).

When pushed to the maximum of presently available performance, CCD cameras do not enable more than seventy-five images to be acquired per second.

### OBJECTS AND SUMMARY OF THE INVENTION

The invention seeks to solve the above-mentioned problems.

To this end, and in a first aspect, the invention provides an image acquisition device comprising:
a CMOS type motion-picture camera adapted to acquire images at a speed greater than seventy-five images per second;
a zoom lens; and
a motor-driven zoom control unit that is offset and accessible to the cameraman operating the camera.

Since the device is intended more particularly for playing back sports events, it is essential for it to include a zoom lens and the above-mentioned motor-driven control unit that are offset in order to vary the zoom.

This offset control unit is traditionally accessible via a control desk or via handles of a swivel chair on which the cameraman is installed.

Advantageously, the CMOS type camera has an image acquisition capacity much greater than seventy-five images per second, with this capacity possibly reaching acquisition speeds of several hundreds of images per second.

However, until the invention, CMOS type cameras have never been used in an acquisition device having a zoom lens with motor-driven control unit that is offset in order to vary the zoom.

Presently known CMOS type cameras are designed to operate with photographic lenses having “F” type or “C” type mounts, as are known to the person skilled in the art.

This observation can be explained in particular by the fact that CMOS type cameras have been designed for photographic applications in industrial and scientific fields.

Prior to the invention, it was therefore unimaginable to use a zoom lens on a CMOS type camera together with a motor-driven control unit that is offset.

This prejudice has been overcome by the Applicant, who has shown the specific application for the acquisition device of the present application, namely ultrafast acquisition of images in order to create slow motion under conditions of live TV.

The performance obtained in this field, i.e. obtaining slow motion at five hundred images per second instead of seventy-five images per second as has traditionally been the case, emphasizes the major technical advantages obtained by means of the invention.

In a preferred embodiment, the acquisition device of the invention further comprises an adaptor for optically and mechanically coupling the zoom lens and the camera.

This adaptor makes it possible in particular to make use of the entire surface area of the CMOS sensor.

In a second aspect, the invention provides an image processor device comprising:
an acquisition device as described briefly above; and
a download interface enabling the camera to download files corresponding to an image sequence to a storage unit.

The storage unit may be constituted in particular by a file server.

Downloading may be performed from a buffer memory of the camera or it may be performed directly, which is known as direct “streaming”.

The processor device thus makes it possible to download a sequence of images obtained at a very high speed of acquisition, e.g. into a vehicle that is located remotely from the camera, in order to archive the sequence or enable an operator to process it prior to broadcasting it.

In a first variant embodiment, the download interface include an optical fiber.

This first variant thus makes it possible for the storage unit to be more than two thousand meters away from the camera.

In a second variant embodiment, the download interface make use of an RJ45 type cable which is more robust than an optical fiber.

Preferably, the image processor device of the invention comprises a remote controller for monitoring and controlling the image acquisition device from the storage unit, and more precisely:
a display for displaying the images acquired by the camera, e.g. in PAL format;
a communications channel with the cameraman situated close to the camera;
controls operable remotely for starting, stopping, pausing, or restarting image acquisition; and
controls for controlling the aperture of the camera diaphragm.

An operator situated close to the storage unit can thus view the images being filmed by the camera, seeing them in PAL format, and decide whether or not they should be downloaded, and can act directly and remotely on certain acquisition parameters, such as diaphragm aperture, for example.

The remote operator can also give instructions to the operator situated close to the camera, via the above-mentioned communications channel.

Preferably, the storage unit includes a converter to convert said files into data complying with a standard format, and in particular the DVI, HD, SDI, or PAL format.

This conversion thus enables data to be obtained in a format that is compatible with equipment for processing or broadcasting images, providing it uses the same standard format.

Preferably, this converter is constituted by:
a video card for converting the files into data in DVI format; and
a converter for converting the data form DVI format to SDI or HD format.

Preferably, the image processor device of the invention further comprises means for correcting color.

Such means thus enable an operator to adjust the color of an image or a sequence of images prior to broadcasting it, particular to ensure that image acquired by different cameras have the same visual appearance.

In a third aspect, the invention also provides an image broadcasting device comprising:
an image processor device as described briefly above; and
a unit for broadcasting said SDI or HD format data.

The image broadcasting device of the present invention thus enables image sequences to be broadcast in slow motion and with excellent quality, e.g. comprising five hundred images per second.

Preferably, the image broadcasting device of the invention further comprises a video server for archiving said data in SDI or HD format, and for playing it back, preferably at variable speed.

This characteristic thus makes it possible advantageously to accelerate or slow down the rate at which the slow motion sequence is broadcast as a function of the constraints associated with live TV.

### BRIEF DESCRIPTION OF THE DRAWINGS

Other aspects and advantages of the present invention appear more clearly on reading the following description of particular embodiments, said description being given purely by way of non-limiting example and being made with reference to the accompanying drawings, in which:

FIG. 1 shows an image broadcasting device in accordance with the invention, in a preferred embodiment thereof; and

FIG. 2 shows an adapter used in an image acquisition device in accordance with the invention.

### MORE DETAILED DESCRIPTION

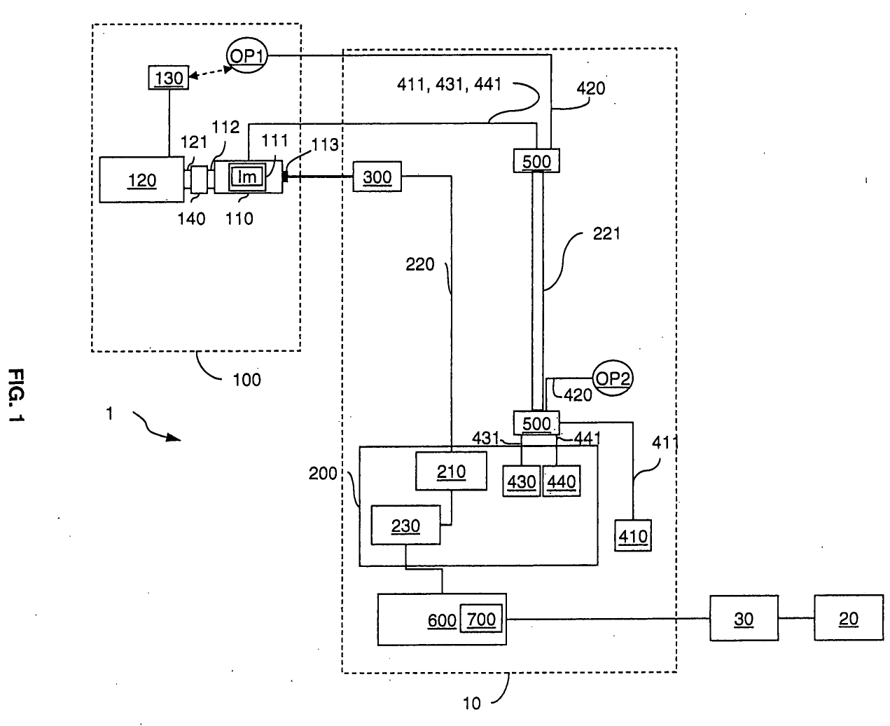

FIG. 1 shows an image broadcasting device 1 in accordance with the invention in a preferred embodiment thereof.

The image broadcasting device 1 includes an image processor device 10 in accordance with the present invention.

The image processor device 10 includes an image acquisition device 100 in accordance with the present invention.

The image acquisition device 100 comprises:
a CMOS type motion-picture camera 110; and
a zoom lens 120.

It is assumed below that the device 100 is used by a cameraman OP1 situated nearby.

In the preferred embodiment described herein, the camera 110 is constituted by the camera sold by Photo-Sonics International Ltd. under the reference “Phantom v7.0”.

The camera has a control unit 130 for varying its focal length, i.e. zooming, this control unit 130 being motor-driven, offset, and accessible to the cameraman OP1.

It enables five hundred images per second to be acquired continuously in a random access memory (RAM) 111 of the camera 110.

In the embodiment described herein, the RAM 111 of the camera 110 has a capacity of eight gigabytes (GB).

In the preferred embodiment described herein, each image Im acquired by the camera 110 is stored in the RAM 111 in the form of a computer file F.

In a variant, a file F could store a sequence of images. The format of the computer files F can be arbitrary.

In the preferred embodiment described herein, the format of these files is specific to the camera 110. It carries the extension “.cin”.

In known manner, the camera 110 includes a ring 112 for coupling to a lens.

In the preferred embodiment described herein, this coupling ring 112 is adapted to the “C” and “F” formats that are known to the person skilled in the art.

In the preferred embodiment described herein, the lens 120 is constituted by the zoom lens sold by the supplier Canon under the reference “DIGI Super 86 XS”. It is a lens having 600×800 square pixels with a side of 22 micrometers (μm).

In the embodiment described herein, the lens 120 has a mount 121 in the B4 format known to the person skilled in the art. It is therefore unsuitable for being mounted directly on the ring 112 of the camera 110.

For this purpose, the acquisition device 100 includes an optical and mechanical adaptor 140 serving:
firstly to allow the lens 120 to be coupled to the camera 110; and
secondly to ensure that the light entering into the lens 120 is compatible with the entire surface of the CMOS sensor.

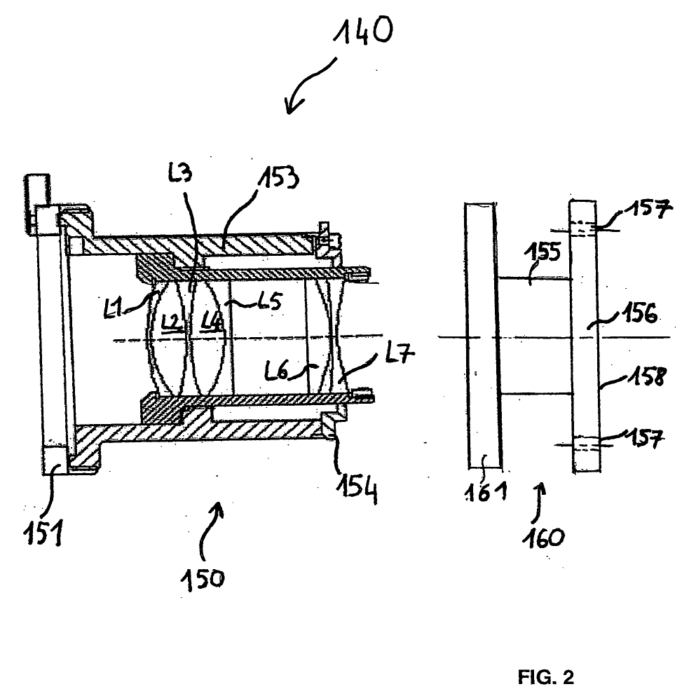

The adaptor 140 is described below with reference to FIG. 2.

Naturally, the person skilled in the art will understand that the adaptor 140 is not necessary if, in some other embodiment of the invention, a camera 110 is used that has a mounting ring 112 that is compatible with the mount 121 of the zoom lens.

In accordance with the invention, the image processor device 10 includes a unit 200 for storing image Im.

In the preferred embodiment described herein, the storage unit 200 is constituted by an industrial personal computer “PC” having 2 gigabits of double data rate dynamic RAM (DDRAM), and a hard disk of the “2×73 GB ultrafast SCSI” type.

In accordance with the invention, the image processor device 200 includes a download interface for downloading an image sequence Im from the memory 112 of the camera 110.

In the preferred embodiment described herein, this download interface comprise software and hardware communications means known to the person skilled in the art and installed in the storage unit 200, i.e. in particular:
a network card 210 together with its drivers; and
software for implementing a standard communications protocol of the TCP/IP, Ethernet, Firewire, etc. type.

This download interface preferably include a physical medium 220 constituted by an optical fiber or an RJ45 Ethernet cable.

In the preferred embodiment described herein, such an Ethernet cable can be directly connected to an output 113 of the camera 110.

When the storage unit 200 is very far from the camera 110, the image processor device 10 further includes an extension module 300 of the type sold by the supplier Tetradis under the reference “Gigabit Extender”.

In manner known to the person skilled in the art, such an extension module 300 is connected to the output 113 of the camera 110 and serves to convey data in the Ethernet gigabit format over a hardened optical fiber of the “multi-mode 62.5-125” type over a distance of about two thousand meters.

In the preferred embodiment described herein, the image processor device 10 includes a remote controller for controlling the image acquisition device 100, and more precisely:
a display 410 for displaying the images acquired by the camera 110 in PAL format; and
an audio-communications channel 420 for communication with the cameraman OP1 situated close to the camera.

The above remote controller is optional.

Furthermore, in the preferred embodiment described herein, the image processor device 10 includes remote controls for controlling the image acquisition device 100, and more precisely:
controls 430 for starting, stopping, pausing, or restarting acquisition of said images; and
controls 440 for controlling the diaphragm aperture of said camera.

In the preferred embodiment described with reference to FIG. 1, the various control and monitoring signals associated with the above-mentioned remote control means are multiplexed over a second optical fiber 221, preferably located in the same protective sheath as the first optical fiber 220.

In the preferred embodiment described herein, these signals conveyed over the second optical fiber 221 are as follows:
a signal 411 transporting the image acquired by the camera 110 in PAL format;
a signal 431 used for starting, stopping, pausing, or restarting image acquisition by the camera 110;
a signal 441 for controlling the diaphragm aperture of the camera 110; and
the communications channel 420 established between the cameraman OP1 close to the camera 110 and the operator OP2 situated close to the storage unit 200.

For this purpose, the image processor device 10 has two multiplexers 500 at the inlet and the outlet of the second optical fiber 221, as shown in FIG. 1. Since signal multiplexing is known to the person skilled in the art, it is not described herein.

Preferably, the storage unit 200 of the invention includes a video card 230 adapted to convert the computer files F of the image sequence Im acquired by the camera 110 into data in DVI format.

In the preferred embodiment described herein, a graphics card is used of the kind sold by the supplier Matrox under the reference “Matrox Parhelia 256 MB”, this card being connected to a PCI bus of the personal computer 200 constituting the storage unit 200.

The processor device 10 of the invention preferably includes a converter 600 suitable for taking the above-mentioned data in DVI format from the storage unit 200 and converting it into data in SDI or HD format.

In the preferred embodiment described herein, the converter 600 is constituted by the converter sold by the supplier Miranda Technologies under the reference “DVI-Ramp”. This converter is suitable for converting the above-mentioned data into a signal complying with the SDI 4.2.2 SMPTE/CCIR 601 Digital standard.

In a preferred embodiment of the invention, the image processor device 10 of the invention further includes means 700 for correcting the color of the images.

In the preferred embodiment described herein, the means 700 for correcting color are provided by the “DVI-Ramp” converter 600.

In accordance with the invention, the image broadcasting device 1 further includes a unit 20 for broadcasting said data in SDI or HD format.

In the preferred embodiment described herein, the broadcasting unit 20 is constituted by satellite broadcasting means.

In a variant, it could be constituted in particular by terrestrial or cable broadcasting unit.

In the preferred embodiment described herein, the broadcasting device 1 further includes a video server 30 for archiving data in SDI or HD format, and for playing it back at variable speed.

A hard disk video server can be used for this purpose, in particular a server of the EVS or the BLT type. Such a server makes it possible to read an SDI or HD signal while simultaneously recording it, at speeds that may vary over the range 0 to 400%.

The image processor device described above thus enables slow motion sequences to be created comprising five hundred images per second of “broadcast” or high definition (HD) quality, and enables such images to be broadcast immediately after they have been acquired, which is compatible with the requirements of real time video verification of refereeing at a sports event.

FIG. 2 shows the adaptor 140 used between the zoom lens 120 and the camera 110 described briefly above.

In the embodiment described herein, the adaptor 140 has an optical portion 150 and a mechanical portion 160. In FIG. 2, these different portions are shown separately.

The optical portion 150 comprises a cylindrical body 153 provided at a first end with a female B4 mount 151 adapted to co-operate with a male B4 mount 121 on the zoom lens 120.

The body 153 of the optical portion 150 comprises, at its second end, a male B4 mount 154 adapted to co-operate with a female B4 mount 161 of the mechanical portion 160.

This female B4 mount 161 is 8 millimeters (mm) thick, and is similar to the female B4 mount 151 of the optical portion 150.

The image from the zoom lens 120 entering the optical portion 150 via its first end is an image in the 11 mm diagonal format.

The optical portion 150 is designed to extend this image so as to form an image with a diagonal of 22 mm at the second end of the optical portion 150.

To this end, the optical portion 150 comprises a support 156 carrying a series of seven lenses referenced L1 to L7 in the diagram of FIG. 2.

These seven lenses in alignment on the optical axis H are respectively as follows:
L1: converging meniscus;
L2: biconvex lens;
L3: biconcave lens;
L4: biconvex lens;
L5: plano-concave lens;
L6: plano-concave lens;
L7: biconcave lens.

This optical portion 150 is characterized by a 48 mm back focus.

The person skilled in the art will understand that the mechanical portion 160 of the adaptor 140 is adapted to a sharp image to be obtained on the sensor of the CMOS type camera 110, taking appropriate account of the back focus of the optical portion 150.

To this end, the mechanical portion 160 comprises, in line with the female B4 mount 161, a cylinder 155 having a diameter of 43 mm and a length of 27 mm.

The cylinder 155 is extended at its other end by a plate 156 having a thickness of 5 mm. This plate 156 has four holes 157 making it possible in known manner to fasten the mechanical portion 160 to the camera 110.

In this preferred embodiment, when the camera 110 is fastened to the mechanical portion 160 of the adaptor 140, its CMOS sensor is at 8 mm from the outside surface 158 of the mechanical portion.

1. An image acquisition device comprising:
a motion-picture camera;
a zoom lens; and
a motor-driven zoom control unit that is offset and accessible to a cameraman operating said camera;
wherein said camera is a CMOS type camera adapted to acquire said images at a speed greater than seventy-five images per second.

2. An acquisition device according to claim 1, further comprising an optical and mechanical adaptor between said lens and said camera.

3. An image processor device, comprising:
an acquisition device according to claim 1; and
a download interface for downloading files from said camera corresponding to sequences of images acquired by said camera and storing them in a storage unit.

4. An image processor device according to claim 3, wherein said download interface include an optical fiber or an RJ45 type cable.

5. An image processor device according to claim 3, including a remote controller for remotely controlling and/or monitoring said image acquisition device from said storage unit.

6. A processor device according to claim 5, wherein said remote controller comprise at least one element selected from:
a display for displaying said images in PAL format; and
an audio-communications channels for communicating with the cameraman situated close to said camera.

7. An image processor device according to claim 5, wherein said remote controller comprise at least one element selected from:
controls for starting, stopping, pausing, or restarting acquisition of said images remotely; and
means for controlling the diaphragm aperture of said camera.

8. An image processor device according to claim 3, wherein said storage unit includes a converter to convert said files into data in compliance with a standard format, and in particular into DVI, HD, SDI, or PAL format.

9. An image processor device according to claim 8, wherein said converter is constituted by:
a video card for converting said files into data in DVI format; and
a converter for converting said DVI format data into SDI or HD format.

10. An image processor device according to claim 3, further including means for correcting color.

11. An image broadcasting device, comprising:
an image processor device according to claim 8; and
a unit for broadcasting said data in SDI or HD format.

12. An image broadcasting device according to claim 11, further including a video server for archiving said data in SDI or HD format, and for playing it back, preferably at variable speed.

13. The use of an image processor device according to claim 3, for creating slow motion images at more than seventy-five images per second, and in particular at 500 images per second.

14. The use of an image broadcasting device according to claim 11, for broadcasting in slow motion at more than seventy-five images per second, and in particular at 500 images per second, under live broadcasting conditions, preferably immediately after the images have been acquired.

15. The use of an image broadcasting device according to claim 14, for real time verification in support of refereeing in a sports event.
